(19) United States
(12) Patent Application Publication
(10) Pub. No.: US 2017/0054717 A1
(43) Pub. Date: Feb. 23, 2017

(54) COMMUNICATION METHOD, COMMUNICATION TERMINAL APPARATUS, AND COMMUNICATION NETWORK SYSTEM

(71) Applicant: FUJITSU LIMITED, Kawasaki-shi (JP)

(72) Inventor: KOSUKE MATSUDA, Kawasaki (JP)

(73) Assignee: FUJITSU LIMITED, Kawasaki-shi (JP)

(21) Appl. No.: 15/220,384

(22) Filed: Jul. 26, 2016

(30) Foreign Application Priority Data
Aug. 20, 2015 (JP) 2015-162850

(51) Int. Cl. H04L 29/06

(52) U.S. Cl. CPC H04L 63/0876; H04L 63/0823; H04W 84/18

(57) ABSTRACT

A communication method executed by a communication terminal apparatus that performs wireless communication with another communication terminal apparatus, the method includes receiving authentication information of the another communication terminal apparatus from the another communication terminal apparatus, the authentication information indicating whether authentication has been performed through an authentication station; determining reliability of a route from the communication terminal apparatus to the another communication terminal apparatus based on the received authentication information of the another communication terminal apparatus and the authentication information of the communication terminal apparatus; transmitting first data and second data having a lower importance than the first data to the another communication terminal apparatus, when the reliability is equal to or higher than a threshold; and transmitting the second data to the another communication terminal apparatus without transmitting the first data to the another communication terminal apparatus, when the reliability is lower than the threshold.

### CROSS-REFERENCE TO RELATED APPLICATION

This application is based upon and claims the benefit of priority of the prior Japanese Patent Application No. 2015-162850, filed on Aug. 20, 2015, the entire contents of which are incorporated herein by reference.

### FIELD

The embodiments discussed herein are related to a communication method, a communication terminal apparatus, and a communication network system.

### BACKGROUND

Recently, ad-hoc network systems are attracting attention. An ad-hoc network system is, for example, a communication network system that communication terminal apparatuses (or nodes) themselves that are mutually coupled temporarily create in an autonomous distributed manner without using an existing infrastructure such as a wireless base station apparatus (these communication terminal apparatuses will sometimes be referred to below as terminals). The ad-hoc network system is advantageous in that since terminals can create a network together in an autonomous distributed manner, while, for example, a desired communication network is being flexibly created, its communication area can be expanded. In the ad-hoc network system, terminals can mutually communicate without using a wireless base station apparatus that is permanently installed and the like. Therefore, another advantage is that a network can be created at a low cost when compared with a network system in which an infrastructure as described above is used. An ad-hoc network system may be referred to as a multi-hop network system, a mesh network system, and the like.

An example of a technology concerning an ad-hoc network system is, for example, a secure network creating system in which a device creates a device certificate that certifies the device, signs the created device certificate by using a network certificate, and sends the signed device certificate to a mobile terminal; the mobile terminal sets the device certificate in the device (see Japanese Laid-open Patent Publication No. 2007-74393, for example).

According to this technology, it is possible to provide a system that can easily create a safe ad-hoc network system without accessing an authentication station that authenticates individual devices.

For the secure network creating system described above, a discussion has been made about, for example, authentication of each device through a mobile terminal without accessing the authentication station, but a discussion has not been made about communication among devices after authentication.

In the secure network creating system described above, there is a case in which a network is created between two end-to-end devices in each of which a device certificate has been set to authenticate the device. In this situation, an authenticated relay device between the two end-to-end devices may move beyond a communication range within which the two end-to-end devices can mutually communicate and an unauthenticated device moves into the communication range. In this case, the unauthenticated device works as a relay terminal, so communication between the two end-to-end devices is disabled.

### SUMMARY

According to an aspect of the invention, a communication method executed by a communication terminal apparatus that performs wireless communication with another communication terminal apparatus, the communication method includes receiving authentication information of the another communication terminal apparatus from the another communication terminal apparatus, the authentication information indicating whether authentication has been performed through an authentication station; determining reliability of a route from the communication terminal apparatus to the another communication terminal apparatus based on the received authentication information of the another communication terminal apparatus and the authentication information of the communication terminal apparatus; transmitting first data and second data having a lower importance than the first data to the another communication terminal apparatus, when the reliability is equal to or higher than a threshold; and transmitting the second data to the another communication terminal apparatus without transmitting the first data to the another communication terminal apparatus, when the reliability is lower than the threshold.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the structure of a communication network system;

FIG. 2 illustrates an example of the structure of the communication network system;

FIG. 3 illustrates an example of the structure of the communication terminal apparatus;

FIG. 4 illustrates an example of the structure of the communication network system;

FIG. 5 illustrates an example of the structure of the communication network system;

FIG. 6 illustrates an example of the structure of the communication network system;

FIG. 7 is a flowchart representing an example of operation;

FIG. 8 illustrates an example of authenticated terminal information;

FIG. 9 illustrates an example of a transmission and reception data identification table;

FIGS. 10A, 10B, and 10C each illustrate an example of an ID comparison packet;

FIG. 11 illustrates an example of a reliability evaluation route table;

FIGS. 12A and 12B each illustrate an example of information about authenticated terminals;

FIGS. 13A, 13B, and 13C each illustrate an example of a transmission packet;

FIGS. 14A and 14B each illustrate an example of an ID comparison packet;

FIG. 15 illustrates an example of a reliability evaluation route table;

FIG. 16 illustrates an example of the hardware structure of the communication terminal apparatus; and

FIG. 17 illustrates an example of the hardware structure of an authentication station apparatus.

### DESCRIPTION OF EMBODIMENTS

Embodiments of the present disclosure will be described below. Examples described below do no restrict the disclosed technology. The embodiments may be appropriately combined within a range in which any contradiction does not occur in processing.

### First Embodiment

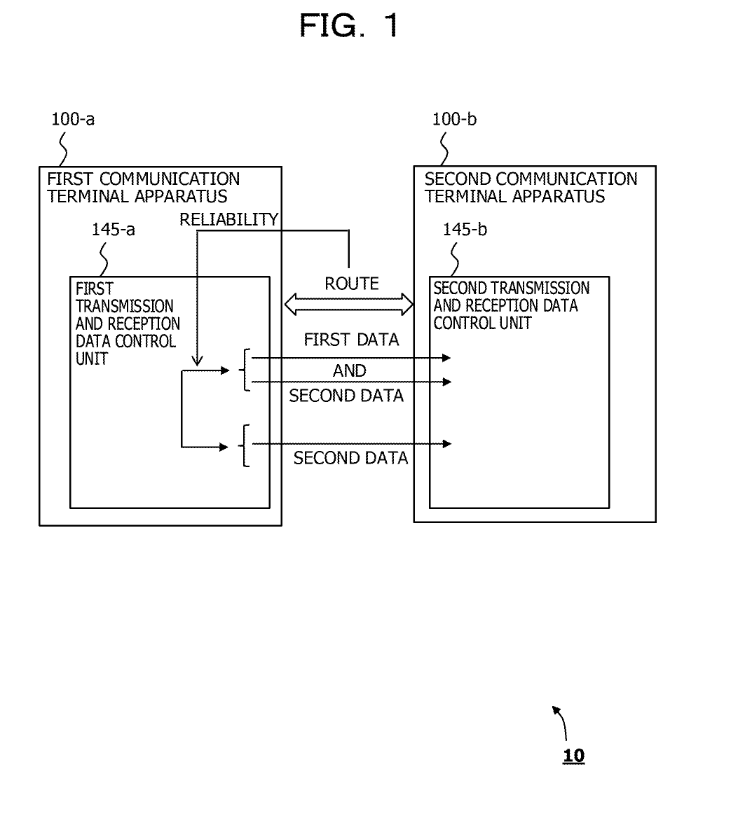

A first embodiment will be described. FIG. 1 illustrates an example of the structure of a communication network system 10 in the first embodiment. The communication network system 10 includes a first communication terminal apparatus 100-a and a second communication terminal apparatus 100-b.

The communication network system 10 is, for example, an ad-hoc network system. An ad-hoc network system is a system in which, for example, the first communication terminal apparatuses 100-a and second communication terminal apparatus 100-b can wirelessly communicate with each other without using an existing infrastructure such as a base station apparatus.

The first communication terminal apparatus 100-a includes a first transmission and reception data control unit 145-a. The second communication terminal apparatus 100-b includes a second transmission and reception data control unit 145-b.

The first transmission and reception data control unit 145-a transmits both first data and second data or one of the first data and second data, according to the reliability of a route from the first communication terminal apparatus 100-a to the second communication terminal apparatus 100-b.

The second transmission and reception data control unit 145-b receives the both first data and second data, which have been transmitted from the first communication terminal apparatus 100-a, or one of the first data and second data.

For example, it is also possible for the first communication terminal apparatus 100-a to transmit the second data, which is less important than the first data, and not to transmit the first data. Even if, for example, the second communication terminal apparatus 100-b is an unauthenticated communication terminal apparatus and the reliability of the route is thereby lower than a first threshold, it is possible for the first communication terminal apparatus 100-a to transmit the second data and not to transmit the first data. Therefore, since the first communication terminal apparatus 100-a transmits the second data to the second communication terminal apparatus 100-b, minimum communication is enabled in the communication network system 10. Even if the first communication terminal apparatus 100-a transmits both the first data and second data, it can be said that minimum communication is enabled because much more data can be transmitted than when only the second data is transmitted.

The first communication terminal apparatus 100-a can also transmit, for example, the second data, which is less important than the first data. Therefore, since the first communication terminal apparatus 100-a transmits the second data, which is less important than the first data, and does not transmit the first data, which is more important than the second data, the first communication terminal apparatus 100-a can assure security in communication.

### Second Embodiment

Next, a second embodiment will be described.

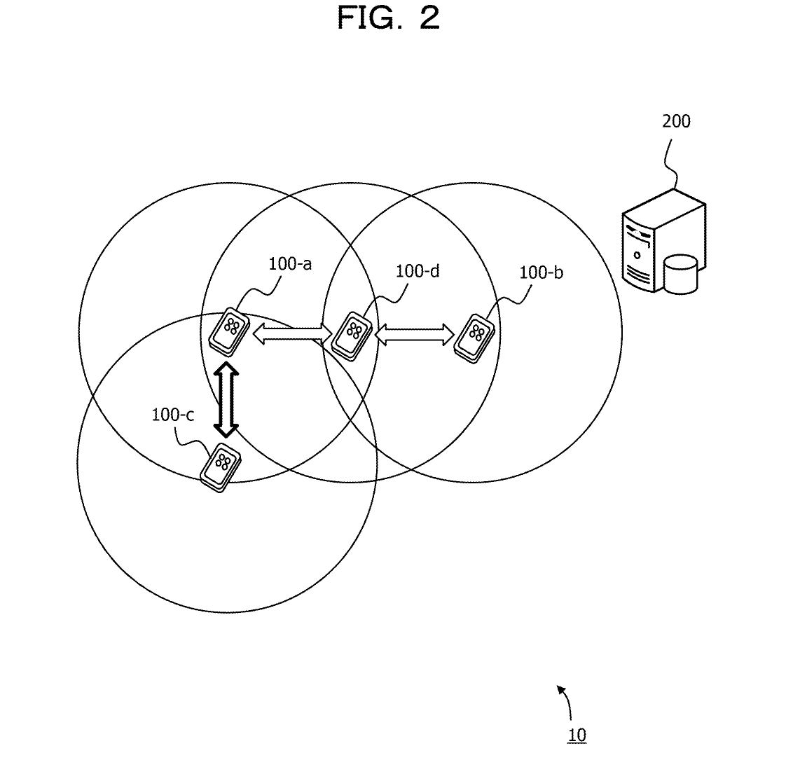

FIG. 2 illustrates an example of the structure of the communication network system 10 in the second embodiment. The communication network system 10 includes a plurality of communication terminal apparatuses (sometimes referred to below as the terminals) 100-a to 100-d and an authentication station apparatus (sometimes referred to below as the authentication station) 200.

The terminals 100-a to 100-d are each, for example, a smart phone, a feature phone, a personal computer, a game apparatus, or another mobile wireless communication apparatus. The terminals 100-a to 100-d can perform wireless communication among them without using an existing infrastructure such as a base station apparatus.

The authentication station 200 performs authentication processing for the terminals 100-a to 100-d. Known authentication processing, for example, is suffices as the authentication processing. In authentication processing, a network certificate and a device certificate may be used as described in Japanese Laid-open Patent Publication No. 2007-74393 quoted above.

The communication network system 10 is a communication network system that terminals that are mutually coupled temporarily create together in an autonomous distributed manner, without using an existing infrastructure such as a wireless base station apparatus. This type of network system is sometimes referred to as, for example, an ad-hoc network system.

In FIG. 2, the terminals 100-a to 100-c have been authenticated at the authentication station 200. However, the terminal 100-d has not been authenticated at the authentication station 200. In the second embodiment, even if a terminal that has not been authenticated at the authentication station 200, such as the terminal 100-d, is present in the communication range within which the two terminals 100-a and 100-b can mutually communicate, the two terminals 100-a and 100-b can transmit and receive data. In this case, however, a restriction is imposed on transmission data; only certain transmission data can be transmitted and transmission of other transmission data is suppressed.

Next, an example of the structure of the terminals 100-a to 100-d will be described. The terminals 100-a to 100-d have the same structure, so unless otherwise noted, they will be described below as the terminal 100.

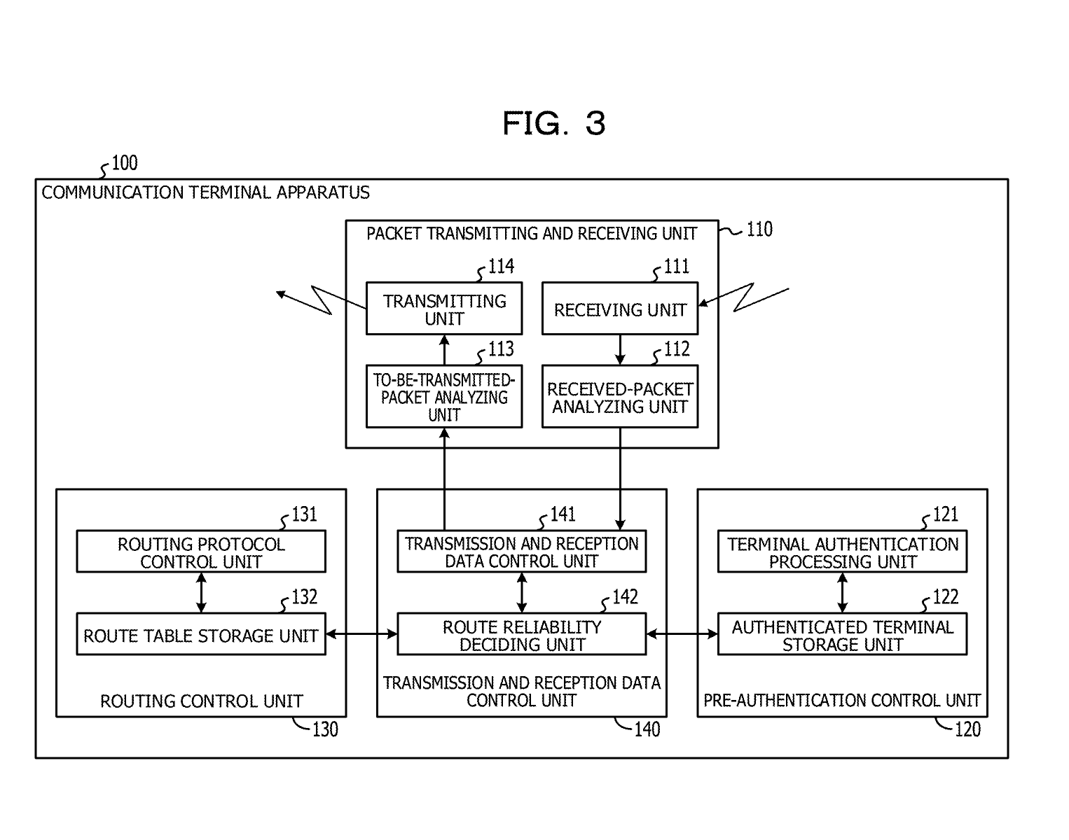

FIG. 3 illustrates an example of the structure of the terminal 100. The terminal 100 includes a packet transmitting and receiving unit 110, a pre-authentication control unit 120, a routing control unit 130, and a transmission and reception data control unit 140.

The packet transmitting and receiving unit 110 has a function that transmits a packet and receives a packet to and from other terminals. The packet transmitting and receiving unit 110 also has a function that transmits a packet and receives a packet to and from the authentication station 200. The packet transmitting and receiving unit 110 includes a receiving unit 111, a received-packet analyzing unit 112, a to-be-transmitted-packet analyzing unit 113, and a transmitting unit 114.

The receiving unit 111 receives packet data (sometimes referred to below as a packet) transmitted from another terminal or the authentication station 200 and outputs the received packet to the received-packet analyzing unit 112. For example, the receiving unit 111 receives a radio signal transmitted from another terminal or the authentication station 200, performs demodulation processing, error correction and decoding processing, and other processing on the received radio signal, after which the receiving unit 111 extracts a packet from the radio signal.

The received-packet analyzing unit 112 analyzes the packet to check or analyze the transmission source and transmission destination of the packet, its type, and the like. The received-packet analyzing unit 112 outputs the checked or analyzed packet to the transmission and reception data control unit 140.

The to-be-transmitted-packet analyzing unit 113 receives a packet that has been output from the transmission and reception data control unit 140 and the like, and checks or analyzes the transmission source and transmission destination of the received packet and the like. The to-be-transmitted-packet analyzing unit 113 outputs the checked or analyzed packet to the transmitting unit 114.

The transmitting unit 114 transmits the packet received from the to-be-transmitted-packet analyzing unit 113 to another terminal and the authentication station 200. To transmit the packet, the transmitting unit 114 performs error correcting coding processing, modulation processing, and other processing on the packet to convert the packet to a radio signal and transmits the radio signal, for example.

The pre-authentication control unit 120 has a function that performs processing to authenticate the terminal 100 and a function that stores information about the authenticated terminal. The pre-authentication control unit 120 includes a terminal authentication processing unit 121 and an authenticated terminal storage unit 122.

The terminal authentication processing unit 121 controls processing concerning the authentication of the terminal 100 through the authentication station 200. Known authentication processing is suffices as the authentication processing. An example of authentication processing is as follows; the terminal authentication processing unit 121 receives a network certificate issued from the authentication station 200 through the packet transmitting and receiving unit 110, transmission and reception data control unit 140, and authenticated terminal storage unit 122 and creates a device certificate signed with the received network certificate. The terminal authentication processing unit 121 transmits the created device certificate to the authentication station 200 through the authenticated terminal storage unit 122, transmission and reception data control unit 140, and packet transmitting and receiving unit 110. Accordingly, the terminal 100 is authenticated at the authentication station 200, after which the terminal 100 can create a route on an ad-hoc network together with another terminal and can transmit data and receive data to and from the other terminal.

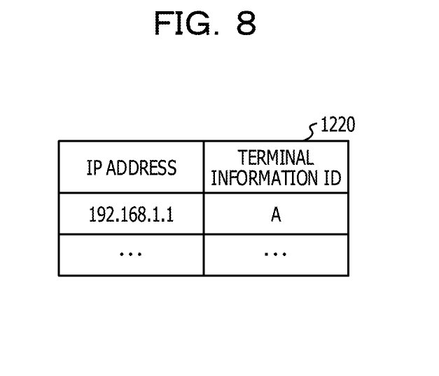

The authenticated terminal storage unit 122 is a memory that stores authenticated terminal information. FIG. 8 illustrates an example of authenticated terminal information 1220. The authenticated terminal information 1220 includes the Internet protocol (IP) address of the terminal 100 and its terminal information identification (ID). The terminal information ID is, for example, information indicating the reliability of the terminal 100. Specifically, the terminal information ID indicates whether the terminal has been authenticated by the authentication station 200. For example, if the terminal 100 has been authenticated at the authentication station 200, the terminal information ID is A, assuming that the reliability of the terminal 100 is equal to or higher than a third threshold. If the terminal 100 has not been authenticated at the authentication station 200, the terminal information ID is X or the like, assuming that the reliability of the terminal 100 is lower than the third threshold. If, the terminal 100 is authenticated at the authentication station 200, the terminal information ID is changed from X to A. Upon the completion of the authentication processing through the authentication station 200, the terminal authentication processing unit 121 may store the terminal information ID in the authenticated terminal storage unit 122.

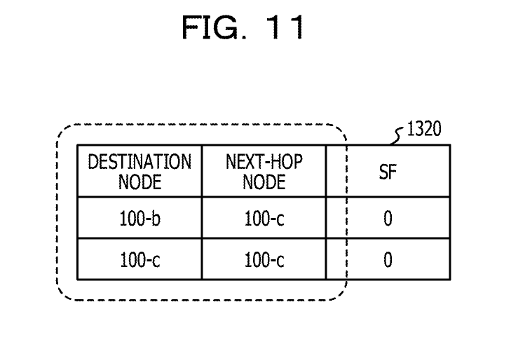

Referring again to FIG. 3, the routing control unit 130 has a function to create a route table. The portion enclosed by the dotted line in FIG. 11 illustrates an example of a route table. The route table is, for example, information indicating a list of routes on a network created between terminals 100. The route table includes, for example, the IP address of a terminal 100 from which packet data has been transmitted, the IP address of a next-hop terminal after the terminal 100, and other information, as illustrated in FIG. 11.

Referring again to FIG. 3, the routing control unit 130 includes a routing protocol control unit 131 and a route table storage unit 132.

The routing protocol control unit 131 uses a routing protocol to exchange control packets and the like with another terminal and create a route table. An on-demand (or reactive) protocol such as the Ad-hoc On-demand Distance Vector (AODV) protocol or Dynamic Source Routing (DSR) protocol, for example, may be used as the routing protocol. Alternatively, an active (or proactive) protocol such as the Optimized Link State Routing (OLSR), for example, may be used as the routing protocol. The routing protocol control unit 131 may create a route table by performing processing to, for example, transmit a communication requesting packet conforming to the above protocol and the like to another terminal and receive a response packet returned in response to the communication requesting packet from the other terminal.

The route table storage unit 132 stores the route table created by the routing protocol control unit 131. The route table storage unit 132 stores a reliability evaluation route table. FIG. 11 illustrates an example of a reliability evaluation route table 1320. The reliability evaluation route table 1320 is, for example, a table in which SF values are added to the route table. An SF value indicates, for example, the reliability of a route. An SF value is created by the route reliability deciding unit 142 and is added to the route table stored in the route table storage unit 132, after which the resulting table is stored in the route table storage unit 132, creating the reliability evaluation route table 1320. The reliability evaluation route table 1320 will be described later in detail.

Referring again to FIG. 3, the transmission and reception data control unit 140 has, for example, a function to classify data that can be transmitted or received according to the reliability evaluation route table 1320 and a transmission and reception data identification table. The transmission and reception data control unit 140 includes a transmission and reception data control unit 141 and a route reliability deciding unit 142.

The transmission and reception data control unit 140 receives a packet and the like created by the terminal authentication processing unit 121, routing protocol control unit 131, and the like through the authenticated terminal storage unit 122, route table storage unit 132, and the like. The transmission and reception data control unit 140 outputs the received packets and the like to the to-be-transmitted-packet analyzing unit 113.

The transmission and reception data control unit 140 receives a packet and the like from the received-packet analyzing unit 112 and outputs the received packet to the terminal authentication processing unit 121 or routing protocol control unit 131 according to the type of the packet, its transmission source, and other information. For example, the transmission and reception data control unit 140 outputs a packed received from the authentication station 200 toward the terminal authentication processing unit 121 and outputs a packet concerning a routing protocol toward the routing protocol control unit 131.

The route reliability deciding unit 142 makes a decision about the route reliability according to, for example, a terminal information ID, stored in the authenticated terminal storage unit 122, that was used in a decision about reliability in the past (time (t−1), for example) and a terminal information ID included in a response packet received at present (time t, for example). In the route reliability decision, the route reliability deciding unit 142 may use a terminal information ID stored in the authenticated terminal storage unit 122 after authentication by the authentication station 200 in a period from when the route reliability was decided in the past until the current route reliability is received (from time (t−1) to time t, for example), together with the terminal information ID included in the received response packet. Alternatively, the route reliability deciding unit 142 may make a decision about the route reliability according to the terminal information ID included in the response packet without using the previous terminal information ID stored in the authenticated terminal storage unit 122. The route reliability deciding unit 142 stores the route reliability about which it has made a decision in the reliability evaluation route table 1320 as an SF value. A response packet in which a terminal information ID is included may be referred to as, for example, an ID comparison packet.

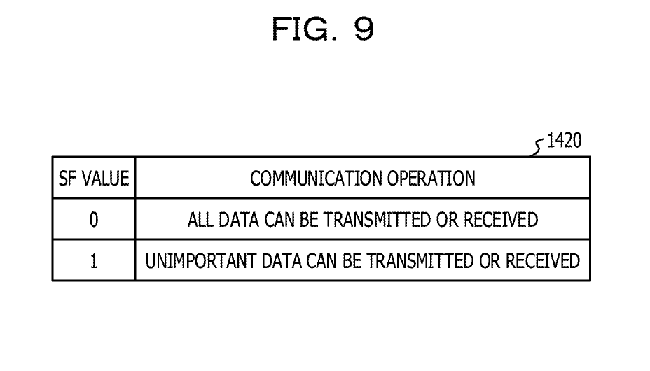

The route reliability deciding unit 142 classifies data that can be transmitted or received according to the reliability evaluation route table 1320 and transmission and reception data identification table. FIG. 9 illustrates an example of a transmission and reception data identification table 1420. The transmission and reception data identification table 1420 is a table that defines a relationship between route reliability and transmission and reception data to be classified. The transmission and reception data identification table 1420 is stored in a memory in the route reliability deciding unit 142 or the like. In this classification, for example, the route reliability deciding unit 142 decides to transmit first transmission data and second transmission data when the route reliability is equal to or higher than the first threshold and to transmit the first transmission data or second transmission data, whichever has an importance lower than a second threshold, when the route reliability is lower than the first threshold. Classification and the transmission and reception data identification table 1420 will be described below in detail.

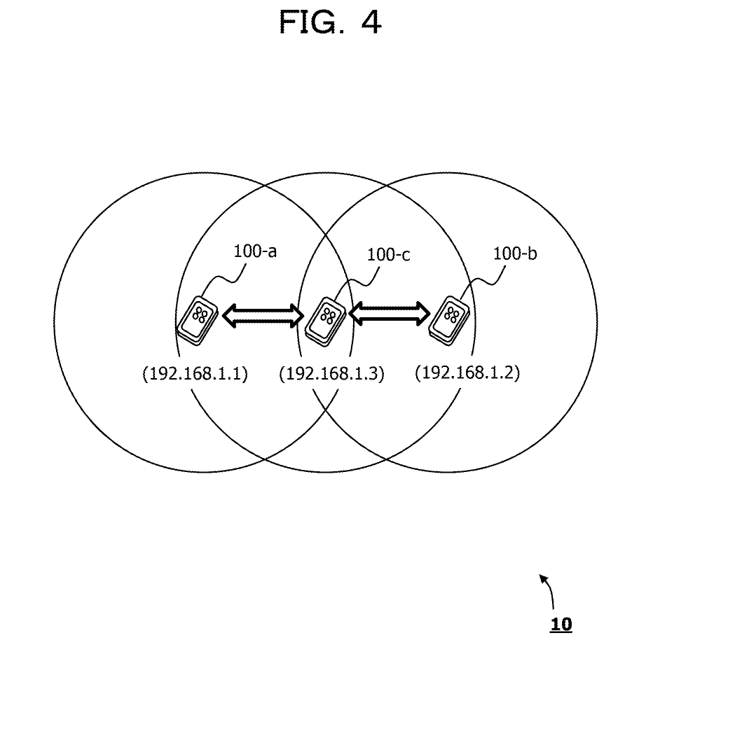

Next, examples of operation will be described with reference to FIGS. 4 to 6. FIGS. 4 to 6 each illustrate an example of creating routes. First, three terminals denoted 100-a, 100-b, and 100-c, which have been authenticated at the authentication station 200 and have reliability equal to or higher than the first threshold, create routes on an ad-hoc network and perform wireless communication, as illustrated in FIG. 4.

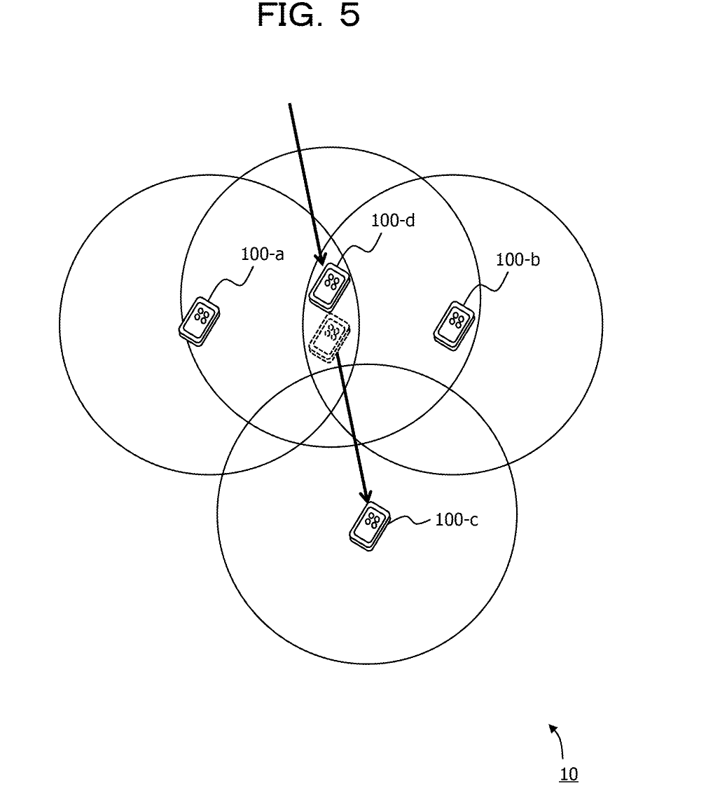

Next, the relay terminal 100-c moves in the direction indicated by an arrow beyond the range within which wireless communication is possible between the terminals 100-a and 100-b, after which the terminal 100-d, which has not been authenticated at the authentication station 200, moves into the range within which wireless communication is possible between the terminals 100-a and 100-b, as illustrated in FIG. 5.

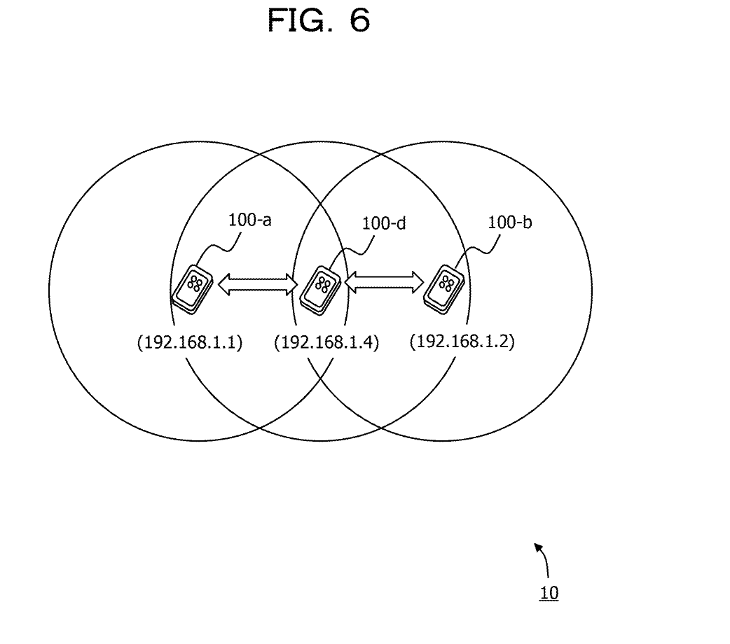

Then, by using the unauthorized terminal 100-d as the relay terminal, wireless communication is performed between the terminals 100-a and 100-b, as illustrated in FIG. 6.

In, for example, FIG. 4, how wireless communication is performed among the three terminals 100-a to 100-c having reliability equal to or higher than the first threshold will be described first as an example of operation. Then, in FIGS. 5 and 6, for example, how wireless communication is performed between the terminals 100-a and 100-b by using the terminal 100-d, which has reliability lower than the first threshold, as a relay terminal will be described.

First, an example of operation at the three terminals 100-a to 100-c as in FIG. 4 will be described. FIG. 4 illustrates an example in which the terminal 100-a transmits transmission data to the terminal 100-b through the terminal 100-c. The description below will be based on this example.

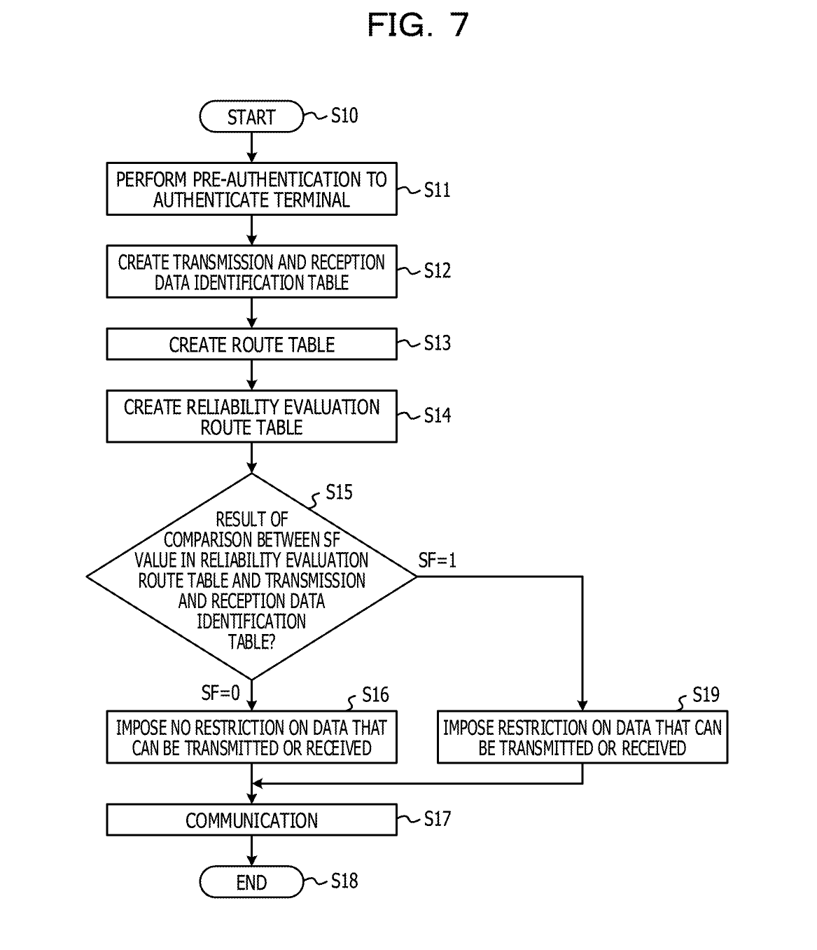

FIG. 7 is a flowchart representing an example of the operation of the terminal 100. In the description below, it will be assumed that the flowchart illustrated in FIG. 7 is executed by the terminal 100-a.

Upon starting processing (S10), the terminal 100-a performs pre-authentication to authenticate itself (S11). In authentication processing, the terminal authentication processing unit 121 exchanges a packet concerning authentication with the authentication station 200, for example. After authentication processing, the terminal authentication processing unit 121 stores, in the authenticated terminal storage unit 122, information indicating that the terminal 100-a is an authorized terminal, as the terminal information ID. FIG. 8 illustrates an example of the authenticated terminal information 1220 stored in the authenticated terminal storage unit 122. In the example in FIG. 8, 192.168.1.1 is stored in the authenticated terminal storage unit 122 as the IP address of the terminal 100-a and A is also stored as the terminal information ID, A indicating that authentication has been performed at the terminal 100-a.

The other terminals 100-b and 100-c also perform pre-authentication through the authentication station 200. In the terminals 100-b and 100-c as well, therefore, A is stored as the terminal information ID.

Referring again to FIG. 7, the terminal 100-a then creates the transmission and reception data identification table 1420 (S12). FIG. 9 illustrates an example of the transmission and reception data identification table 1420. The transmission and reception data identification table 1420 includes an item named “SF value” and another item named “communication operation”. The SF value is, for example, a numeric value indicating the reliability of a route. The communication operation indicates that what data will be transmitted as transmission data depending on the reliability of the route. Specifically, communication operation indicates that when the route reliability is equal to or higher than the first threshold (the SF value is 0), all data items can be transmitted or received and that when the route reliability is lower than the first threshold (the SF value is 1), only unimportant data can be transmitted or received. The route reliability deciding unit 142 may perform this processing by, for example, reading out the transmission and reception data identification table 1420 stored in an internal memory.

Referring again to FIG. 7, the terminal 100-a creates a route table (S13). For example, the routing protocol control unit 131 may create a route table by using the AODV protocol. The terminal 100-a creates a route table as described below, for example.

The routing protocol control unit 131 in the terminal 100-a crates a route request (RREQ) packet that requests communication and outputs the created RREQ packet to the transmission and reception data control unit 141. The transmission and reception data control unit 141 receives the RREQ packet and transmits it to the other terminals 100-b and 100-c by broadcasting. The terminal 100-c receives the RREQ packet transmitted from the terminal 100-a, as illustrated in FIG. 4. The terminal 100-c adds its IP address to the RREQ packet and performs other processing, after which the terminal 100-c transmits the resulting RREQ packet to the terminal 100-b by broadcasting. The terminal 100-b receives the RREQ packet transmitted from the terminal 100-c. Upon the receipt of the RREQ packet, the terminal 100-b creates a route reply (RREP) packet, which is a response to the RREQ packet.

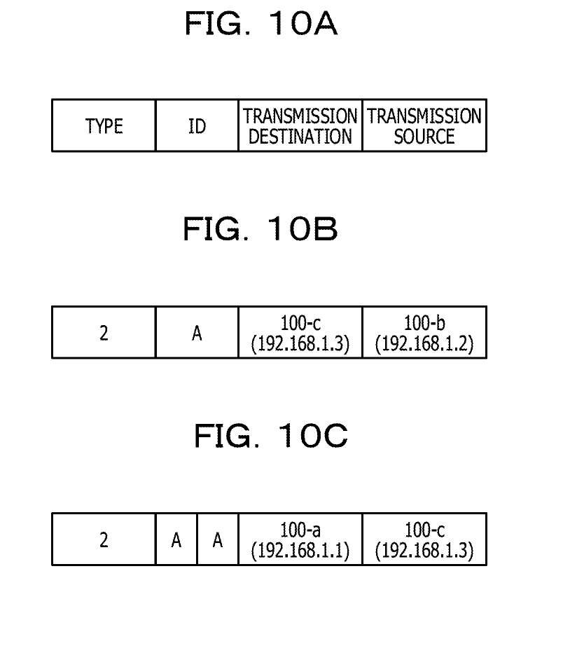

In the second embodiment, the terminal 100-b creates an ID comparison packet, in which a terminal information ID (A, for example) is added to the RREP packet. FIG. 10A illustrates an example of an ID comparison packet. The ID comparison packet includes a type field indicating that the packet is an ID comparison packet, an ID field in which a terminal information ID is entered, a transmission destination field indicating the transmission destination of the ID comparison packet, and a transmission source field indicating a transmission source from which the ID comparison packet has been transmitted.

FIG. 10B illustrates an example of an ID comparison packet created by the terminal 100-b. As illustrated in FIG. 10B, at the terminal 100-b, A is entered into the ID field, A being the terminal information ID indicating that the terminal 100-b has been authenticated at the authentication station 200. In this case, the routing protocol control unit 131 in the terminal 100-b reads out the terminal information ID of the terminal 100-b from the authenticated terminal storage unit 122 through the transmission and reception data control unit 140 and creates an ID comparison packet that includes the terminal information ID. In this case, it suffices for the routing protocol control unit 131 to create an ID comparison packet in which the transmission source of the RREQ packet received from the terminal 100-c is the transmission destination (192.168.1.3) and the terminal 100-b is the transmission source (192.168.1.2). Thus, the ID comparison packet transmitted from the terminal 100-b goes to the terminal 100-c, as illustrated in FIG. 4.

The terminal 100-c adds its terminal information ID (A, for example) to the ID comparison packet received from the terminal 100-b and transmits the resulting ID comparison packet to the terminal 100-a. FIG. 10C illustrates an example of an ID comparison packet that the terminal 100-c transmits to the terminal 100-a. In this case, the routing protocol control unit 131 in the terminal 100-c reads out the terminal information ID of the terminal 100-c from the authenticated terminal storage unit 122 through the transmission and reception data control unit 140. The routing protocol control unit 131 rewrites the transmission destination and transmission source of the ID comparison packet received from the terminal 100-b so that the transmission source of the RREQ packet received from the terminal 100-a is set as the transmission destination (192.168.1.1) and the terminal 100-c is set as the transmission source (192.168.1.3). Thus, the ID comparison packet transmitted from the terminal 100-c goes to the terminal 100-a, as illustrated in FIG. 4.

Upon the receipt of the ID comparison packet, the terminal 100-a creates a route table according to the information included in the ID comparison packet. Although not illustrated in FIG. 10C and other drawings, the ID comparison packet includes the IP address of a terminal that had received a RREQ packet and has returned a RREP packet or the IP address of a relay terminal that has relayed a RREP packet, as in the RREP packet. It suffices for the routing protocol control unit 131 in the terminal 100-a to create a route table according to information about IP addresses included in the ID comparison packet, the sequence in which the information is entered, and other information.

The portion enclosed by the dotted line in FIG. 11 illustrates an example of a route table created at the terminal 100-a. In the route table, the IP addresses of the terminals 100 at the destination node and next-hop node are stored. In the example in FIG. 11, there is an entry in which the IP address of the terminal 100-c is stored as the destination node. This indicates an example in a case in which the terminal 100-c had created an ID comparison packet in response to an RREQ packet transmitted from the terminal 100-a and has transmitted the ID comparison packet to the terminal 100-a.

Referring again to FIG. 7, the terminal 100-a creates a route table (S13) and then creates the reliability evaluation route table 1320 (S14). FIG. 11 illustrates an example of the reliability evaluation route table 1320. The route reliability deciding unit 142 in the terminal 100-a makes a decision about the reliability of the route according to the previous terminal information ID stored in the authenticated terminal storage unit 122 and the terminal information ID included in the ID comparison packet that has been received this time.

The route reliability deciding unit 142 makes a decision about the reliability of the route as described below, for example. If all of the terminal information IDs, stored in the authenticated terminal storage unit 122, of the terminals 100-b and 100-c are A and all of the terminal information IDs, included in the ID comparison packets received this time, of the terminals 100-b and 100-c are also A, the route reliability deciding unit 142 sets the SF value to 0. This is because the route reliability deciding unit 142 decides that the reliabilities of the previous route and current route are equal to or higher than the first threshold, so the route reliability deciding unit 142 sets the SF value to 0.

If part of the terminal information IDs, stored in the authenticated terminal storage unit 122, of the terminals 100-b and 100-c is A or all of them are X and all of the terminal information IDs, included in the ID comparison packets received this time, of the terminals 100-b and 100-c are A, the route reliability deciding unit 142 sets the SF value to 0. In this case, although the previous route reliability was lower than the first threshold, the reliability is improved at present; the current route reliability is equal to or higher than the first threshold. Therefore, the route reliability deciding unit 142 decides, according to the current reliability, that the route reliability is equal to or higher than the first threshold, and sets the SF value to 0.

If all of the terminal information IDs, stored in the authenticated terminal storage unit 122, of the terminals 100-b and 100-c are A and part of the terminal information IDs, included in the ID comparison packets received this time, of the terminals 100-b and 100-c is A or all of them are X, the route reliability deciding unit 142 sets the SF value to 1. In this case, although the previous route reliability was equal to or higher than the first threshold, the current route reliability is lower than the first threshold at present. Therefore, the route reliability deciding unit 142 decides that the current route reliability is lower than the previous route reliability, and sets the SF value to 1.

If part of the terminal information IDs, stored in the authenticated terminal storage unit 122, of the terminals 100-b and 100-c is A or all of them are X and part of the terminal information IDs, included in the ID comparison packets received this time, of the terminals 100-b and 100-c is also A or all of them are X, the route reliability deciding unit 142 sets the SF value to 1. In this case, neither the previous reliability nor the current reliability was improved, so the route reliability deciding unit 142 decides that the route reliability is lower than the first threshold and sets the SF value to 1.

The route reliability deciding unit 142 may decide the route reliability according to the terminal information IDs included in the received ID comparison packets, without referencing terminal information IDs that are stored in the authenticated terminal storage unit 122 as a previous history. In this case, if all of the terminal information IDs included in the ID comparison packets are A, the route reliability deciding unit 142 sets the SF value to 0; if part of terminal information IDs included in the ID comparison packets is A or all of them are X instead of all of them being A, the route reliability deciding unit 142 sets the SF value to 1.

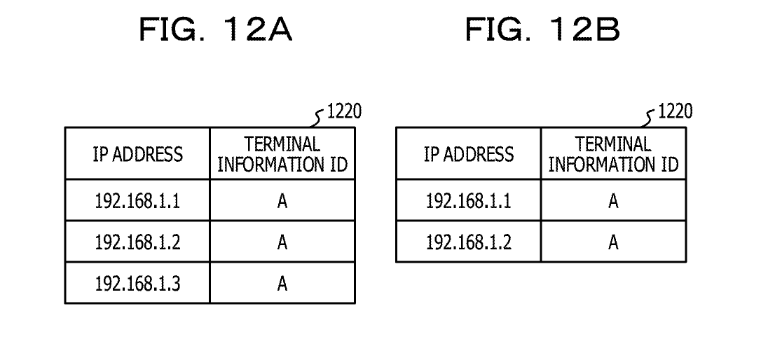

After having created the reliability evaluation route table 1320, the route reliability deciding unit 142 stores, in the authenticated terminal storage unit 122, the terminal information IDs included the ID comparison packets. In this case, all of the terminal information IDs are A, information illustrated in FIG. 12A is stored in the authenticated terminal storage unit 122. In this case, if a terminal information ID stored in the authenticated terminal storage unit 122 is used in a subsequent route reliability decision, the terminal information ID is handled as a previous terminal information ID.

Referring again to FIG. 7, after having created the reliability evaluation route table 1320 (S14), the terminal 100-a compares the SF value in the reliability evaluation route table 1320 with the transmission and reception data identification table 1420 (S15). For example, processing is performed as described below. The route reliability deciding unit 142 reads out the SF value from the reliability evaluation route table 1320 stored in the route table storage unit 132. The route reliability deciding unit 142 then compares the read-out SF value with the corresponding SF value in the transmission and reception data identification table 1420 stored in an internal memory or the like. In this example, the SF value is 0 as illustrated in FIG. 11. Therefore, the route reliability deciding unit 142 makes a comparison with entries, in the transmission and reception data identification table 1420, in which the SF value is 0.

If the SF value is 0 (SF is 0 in S15), the terminal 100-a imposes no restriction on data that can be transmitted or received (S16). For example, the route reliability deciding unit 142 reads out a communication operation corresponding to the SF value of 0 (all data can be transmitted or received) from the transmission and reception data identification table 1420. The route reliability deciding unit 142 then commands the transmission and reception data control unit 141 not to impose a restriction on transmission and reception data. Thus, the transmission and reception data control unit 141 outputs all packets that include, for example, transmission data to the packet transmitting and receiving unit 110.

The terminal 100-a then transmits transmission data to the terminal 100-b through the terminal 100-c and transmits transmission data to the terminal 100-c (S17). All transmission data intended to be exchanged through routes are exchanged without restrictions as illustrated in FIG. 4.

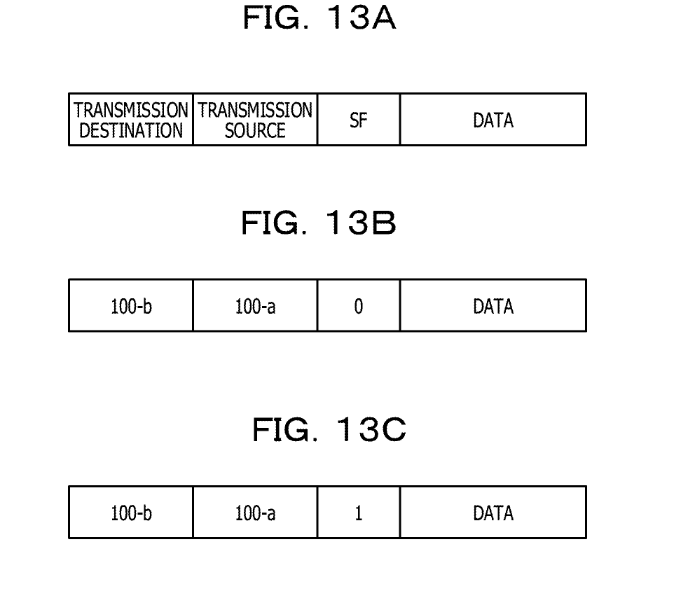

The terminal 100-a may transmit transmission data together with an SF value. FIG. 13A illustrates an example of a transmission packet to which an SF value is added (the packet may be referred to below as the route evaluation information added packet). The route evaluation information added packet includes an SF field, into which an SF value is entered, besides the transmission destination field, transmission source field, and data field. For example, the route reliability deciding unit 142 outputs a decided SF value to the transmission and reception data control unit 141 and commands transmission of transmission data including the SF value. Thus, for example, the transmission and reception data control unit 141 creates a route evaluation information added packet in which the SF value is included in the SF field and transmits the packet to other terminals 100-b and 100-c. Since, in this example, the SF value is 0, a transmission packet illustrated in, for example, FIG. 13B is transmitted. Upon the receipt of the route evaluation information added packet including the SF value, the terminals 100-b and 100-c can grasp the SF value of the route. Therefore, the terminals 100-b and 100-c can determine whether the reliability of the route is equal to or higher than the first threshold or lower than the first threshold. In FIG. 13A, the IP address of the terminal 100 at the transmission destination may be included in the transmission destination field and the IP address of the terminal 100 at the transmission source may be included in the transmission source field, as in the ID comparison packet and the like.

When the terminal 100-c receives the route evaluation information added packet, the route reliability deciding unit 142 in the terminal 100-c may extract the SF value from the packet, may check the SF value, and may store 0 as the SF value in the reliability evaluation route table 1320 for the route from the terminal 100-a to the terminal 100-b. At the 100-b as well, 0 may be stored as the SF value corresponding to the route in the reliability evaluation route table 1320.

Referring again to FIG. 7, the terminal 100-a terminates the series of processing (S18).

Next, an example of a subsequent operation will be described in which the terminal 100-c moves beyond the communication range within which the terminals 100-a and 100-b can mutually communicate and the terminal 100-d, the reliability of which is lower than the first threshold, moves into the communication range as illustrated in FIGS. 5 and 6.

In FIG. 7, the terminal 100-a performs pre-authentication (S11) and creates the transmission and reception data identification table 1420 (S12).

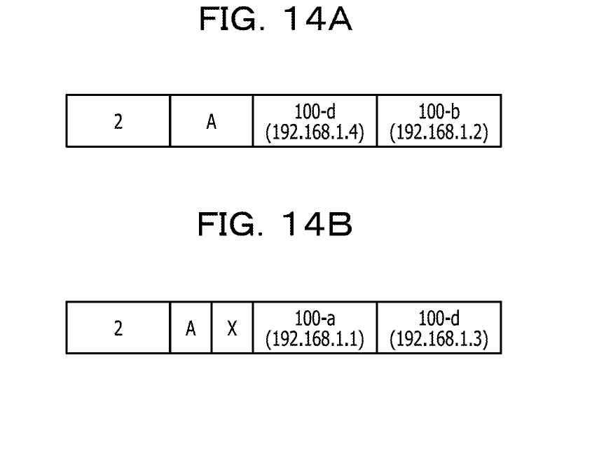

The terminal 100-a then creates a route table (S13). For example, processing is performed as described below. The terminal 100-a transmits a RREQ packet. The RREQ packet is transmitted through the terminal 100-d to the terminal 100-b. The terminal 100-b creates an ID comparison packet in which the transmission source (terminal 100-d) of the RREQ packet is set as the transmission destination, and transmits the ID comparison packet to the terminal 100-d. FIG. 14A illustrates an example of an ID comparison packet transmitted from the terminal 100-b to the terminal 100-d.

Upon the receipt of the ID comparison packet, the terminal 100-d adds its terminal information ID to the ID comparison packet. In this case, since the terminal 100-d has not performed authentication processing through the authentication station 200, the terminal information ID in the authenticated terminal information 1220 is X. Therefore, the terminal 100-d adds X to the ID comparison packet, rewrites the transmission destination (terminal 100-d) of the ID comparison packet to the transmission source (terminal 100-a) of the RREQ packet, and transmits the rewritten ID comparison packet. FIG. 14B illustrates an example of an ID comparison packet transmitted from the terminal 100-d to the terminal 100-a. The terminal 100-a receives the ID comparison packet and creates a route table of the route between the terminal 100-a and the terminal 100-b through the terminal 100-d according to the received ID comparison packet.

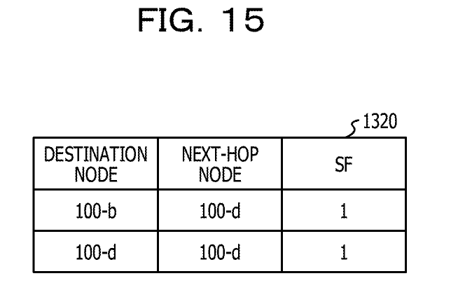

Referring again to FIG. 7, the route reliability deciding unit 142 in the terminal 100-a makes a decision about route reliability according to previous terminal information IDs and the terminal information IDs included in the received ID comparison packets (S14). In this case, all of the previous terminal information IDs (see FIG. 12B, for example) are A and all of the terminal information IDs included in the ID comparison packets received this time are not A but only part of them is A. Therefore, the route reliability deciding unit 142 decide that the reliability of the route to the terminal 100-b through the terminal 100-d is lower than the first threshold. The route reliability deciding unit 142 then stores the SF value of 1 in the reliability evaluation route table 1320. FIG. 15 illustrates an example of the reliability evaluation route table 1320 in which the SF value of 1 is stored.

Referring again to FIG. 7, the terminal 100-a compares the SF value in the reliability evaluation route table 1320 with the transmission and reception data identification table 1420 (S15). In this case, since the SF value is 1 (the SF value is decided to be 1 in S15), the terminal 100-a imposes a restriction on data that can be transmitted or received (S19). For example, the route reliability deciding unit 142 reads out “unimportant data can be transmitted or received”, which is a communication operation effected when the SF value is 1, from the transmission and reception data identification table 1420, and commands the transmission and reception data control unit 141 to enable unimportant data to be transmitted and suppress important data from being transmitted.

The transmission and reception data control unit 141 classifies transmission data into unimportant data and important data according to the command. There may be various criteria according to which transmission data is classified. For example, transmission data may be classified according to its type so that call data is classified as important data and other data is classified as unimportant data. When transmission data is call data, emergency contact numbers and call destinations registered as a telephone book in a memory in the terminal 100 may be classified as important data and other call data may be classified as unimportant data. When transmission data is social networking service (SNS) data, SNS data concerning emergency contacts in case of a disaster may be classified as important data and other SNS data may be classified as unimportant data. As described above, the transmission and reception data control unit 141 may classify transmission data into important data and unimportant data according to the type of transmission data, contact numbers, transmission destinations, the degrees of emergencies, and other parameters. The transmission and reception data control unit 141 may classify transmission data into unimportant data, the importance of which is lower than the second threshold, and important data, the importance of which is equal to or higher than the second threshold, according to a parameter.

Then, the terminal 100-a transmits unimportant data classified as described above to the terminal 100-d on the route (S17) and completes the series of processing (S18).

In this example as well, the terminal 100-a may transmit a route evaluation information added packet. FIG. 13C illustrates an example of a route evaluation information added packet. In this case, an SF value set to 1 is added. When the terminal 100-d receives the route evaluation information added packet, the route reliability deciding unit 142 in the terminal 100-d may extract the SF value from the packet, may check the SF value, and may store 1 as the SF value in the reliability evaluation route table 1320 for the route from the terminal 100-a to the terminal 100-b. At the terminal 100-b as well, 1 may be stored as the SF value in the reliability evaluation route table 1320 for the route.

As described above, in the second embodiment, the terminal 100-a transmits both important data and unimportant data or only unimportant data to the terminal 100-b, according to the reliability of the route from the terminal 100-a to the terminal 100-b.

If, for example, the reliability of the route from the terminal 100-a to the terminal 100-b is lower than the first threshold, the terminal 100-a transmits only unimportant data, the importance of which is lower than the second threshold.

Even if the relay terminal 100-d, which is not authorized, is present on the route, communication between the terminal 100-a and the terminal 100-b is possible, so unimportant data is transmitted. This enables minimum communication. In this case, on the route, unimportant data is transmitted but important data is not transmitted, so communication security is assured.

### Another Embodiment

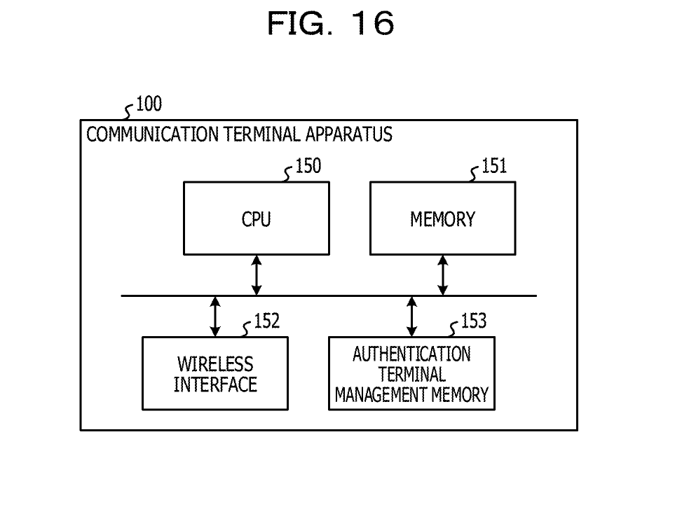

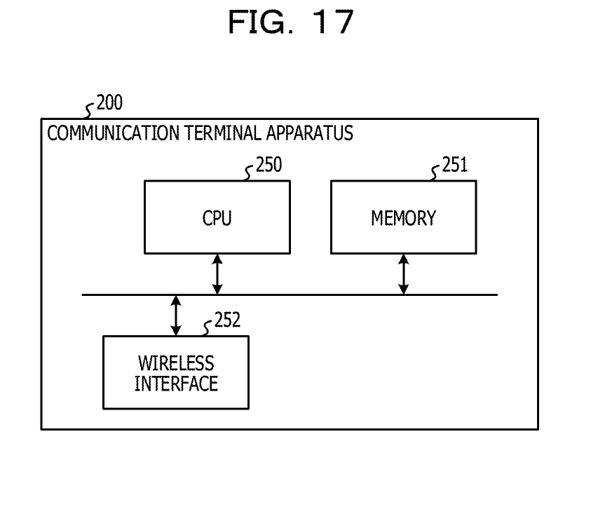

FIG. 16 illustrates an example of the hardware structure of the terminal 100. FIG. 17 illustrates an example of the hardware structure of the authentication station 200.

The terminal 100 includes a central processing unit (CPU) 150, a memory 151, a wireless interface 152, and an authentication terminal management memory 153.

The CPU 150 reads out programs stored in the memory 151 and executes the read-out programs to execute the functions of the terminal authentication processing unit 121, routing protocol control unit 131, transmission and reception data control unit 141, and route reliability deciding unit 142. The CPU 150 corresponds to, for example, the terminal authentication processing unit 121, routing protocol control unit 131, transmission and reception data control unit 141, and route reliability deciding unit 142 in the second embodiment.

The memory 151 stores the programs executed by the CPU 150, the reliability evaluation route table 1320, the transmission and reception data identification table 1420, and the like. The memory 151 corresponds to, for example, the route table storage unit 132 in the second embodiment.

The authentication terminal management memory 153 stores the authenticated terminal information 1220 about the terminal 100. The authentication terminal management memory 153 corresponds to, for example, the authenticated terminal storage unit 122 in the second embodiment.

The wireless interface 152 is an interface through which wireless communication is performed with other terminals and the authentication station 200. The wireless interface 152 corresponds to, for example, the packet transmitting and receiving unit 110 in the second embodiment.

The authentication station 200 includes a CPU 250, a memory 251, and a wireless interface 252. The CPU 250 reads out programs stored in the memory 251 and executes the read-out programs to perform authentication processing for the terminal 100. The memory 251 stores the programs executed by the CPU 250 and the like.

The wireless interface 252 converts data output from the CPU 250 and other data to radio signals and transmits the converted radio signals to the terminal 100. The wireless interface 252 also receives a radio signal transmitted from the terminal 100, extracts data and the like from the received radio signal, and outputs the extracted data and the like to the CPU 250.

Processing and the like described in the second embodiment may be performed at the terminal 100 in FIG. 16 or the authentication station 200 in FIG. 17.

Instead of the CPU 150 in FIG. 16 and the CPU 250 in FIG. 17, a micro processing unit (MPU), a field programmable gate array (FPGA), or another controller may be used.

In the second embodiment described above, an example has been described in which, when the route reliability is lower than the first threshold, the terminal 100-a transmits only unimportant data and does not transmit important data. However, for example, the terminal 100-a may not transmit unimportant data but may transmit important data. There is a case in which emergency information and information about disasters such as an earthquake and a tsunami, for example, are classified as important data. As many users as possible are preferably notified of this type of important data. Therefore, when the route reliability is lower than the first threshold, even if the data is important data, the important data may be transmitted through the route. In this case as well, even if the relay terminal 100-d, which is not authorized by the authentication station 200, is present on the route, important data is transmitted, so minimum communication is possible.

In the second embodiment described above, the SF value, which is an index representing reliability, has been descried as, for example, indicating that the reliability is equal to or higher than the first threshold when the SF value is 0 and that the reliability is lower than the first threshold when the SF value is 1. However, for example, the SF value may indicate that when the SF value is 1, the reliability is equal to or higher than the first threshold and that when the SF value is 0, the reliability is lower than the first threshold. In this case, in the transmission and reception data identification table 1420, “all data can be transmitted or received” may be set for the SF value of 1 and “unimportant data can be transmitted or received” may be set for the SF value of 0.

In the second embodiment described above, an example in which the SF value, which is an index representing reliability, is one of two values, 0 and 1, has been described. However, for example, the SF value may represent reliability by using one of three, four, or more values. In this case, 0 may indicate the highest reliability and 1 may indicate the lowest reliability, or vice versa. In this case, in the transmission and reception data identification table 1420, “all data can be transmitted or received” may be set when the SF value is equal to or lower than the first threshold (or equal to or higher than the first threshold) and “unimportant data can be transmitted or received” may be set when the SF value is higher than the first threshold (or lower than the first threshold).

In addition, the route reliability deciding unit 142 may make a decision about route reliability in such a way that if the number of As included in the ID comparison packets as the terminal information IDs is equal to or larger than a fourth threshold, the reliability is decided to be equal or higher than the first threshold and that if the number of As is smaller than the fourth threshold, the reliability is decided to be lower than the first threshold.

Furthermore, in the authentication of the terminal 100, the terminal 100 may access the authentication station 200 so as to be authenticated. Alternatively, the terminal 100 may be authenticated by exchanging a packet concerning authentication with another terminal that has been authorized, without accessing the authentication station 200. Although an example has been described in which, to represent the reliability of the terminal 100, one of two values, A and X, is used depending on whether the terminal 100 has been authenticated, the reliability of the terminal 100 may be represented by one of three, four, or more values. For example: when the terminal 100 has been authenticated by directly accessing the authentication station 200, the reliability of the terminal 100 may be represented by a numeric value indicating the highest reliability of the terminal 100; when the terminal 100 has been authenticated without accessing the authentication station 200, the reliability of the terminal 100 may be represented by a numeric value indicating the next highest reliability of the terminal 100; and when the terminal 100 has not been authenticated, the reliability of the terminal 100 may be represented by a numeric value indicating the lowest reliability of the terminal 100. In this case, the terminal 100 may enter a value corresponding to the reliability of the terminal 100 in the ID comparison packet without alteration. Alternatively, the terminal 100 may make a decision according to a threshold and may enter one of A and X. The terminal 100-a may make a decision about the route reliability according to the numeric value indicating the reliability of each terminal 100 included in the ID comparison packet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication method executed by a communication terminal apparatus that performs wireless communication with another communication terminal apparatus, the communication method comprising:
receiving authentication information of the another communication terminal apparatus from the another communication terminal apparatus, the authentication information indicating whether authentication has been performed through an authentication station;
determining reliability of a route from the communication terminal apparatus to the another communication terminal apparatus based on the received authentication information of the another communication terminal apparatus and the authentication information of the communication terminal apparatus;
transmitting first data and second data having a lower importance than the first data to the another communication terminal apparatus, when the reliability is equal to or higher than a threshold; and
transmitting the second data to the another communication terminal apparatus without transmitting the first data to the another communication terminal apparatus, when the reliability is lower than the threshold.

2. The communication method according to claim 1, wherein the determining includes:
determining that the reliability is equal to or higher than the threshold, when both the authentication information of the another communication terminal apparatus and the authentication information of the communication terminal apparatus indicate that authentication has been performed through the authentication station, and
determining that the reliability is lower than the threshold, when at least one of the authentication information of the another communication terminal apparatus and the authentication information of, the communication terminal apparatus indicates that authentication has not been performed through the authentication station.

3. The communication method according to claim 1,
wherein the receiving includes obtaining the authentication information of the another authentication information included in a reply packet received by the communication terminal apparatus, the replay packet being transmitted in response to a request packet that requests communication, the request packet being transmitted from the communication terminal apparatus by broadcasting.

4. The communication method according to claim 1, further comprising
executing pre-authentication through the authentication station,
wherein the determining includes determining after the pre-authentication.

5. The communication method according to claim 1, further comprising
storing previous authentication information that includes the authentication information of the another communication terminal apparatus at a first time and the authentication information of the communication terminal apparatus at the first time,
wherein the determining includes determining the reliability of the route based on the previous authentication information, the authentication information of the another communication terminal apparatus received at a second time which is later than the first time, and the authentication information of the communication terminal apparatus in a period from the first time to the second time.

6. The communication method according to claim 5,
wherein the determining includes determining that the reliability is equal to or higher than the threshold, regardless of contents of the previous authentication information, when both the authentication information of the another communication terminal apparatus received at the second time and the authentication information of the communication terminal apparatus in the period from the first time to the second time indicate that authentication has been performed through the authentication station.

7. The communication method according to claim 1,
wherein the receiving includes receiving the authentication information of a relay apparatus, which belong to the route and relays communication from the another communication terminal apparatus to the communication terminal apparatus.

8. The communication method according to claim 1, wherein the authentication information is represented by a numeric value that depends on whether authentication has been performed through the authentication station.

9. A communication terminal apparatus that performs wireless communication with another communication terminal apparatus, the communication terminal apparatus comprising:
a memory; and
a processor coupled to the memory and configured to:
receive authentication information of the another communication terminal apparatus from the another communication terminal apparatus, the authentication information indicating whether authentication has been performed through an authentication station,
determine reliability of a route from the communication terminal apparatus to the another communication terminal apparatus based on the received authentication information of the another communication terminal apparatus and the authentication information of the communication terminal apparatus,
transmit first data and second data having a lower importance than the first data to the another communication terminal apparatus, when the reliability is equal to or higher than a threshold, and
transmit the second data to the another communication terminal apparatus without transmitting the first data to the another communication terminal apparatus, when the reliability is lower than the threshold.

10. A communication network system, comprising:
a first communication terminal apparatus; and
a second communication terminal apparatus that is capable of wirelessly communicating with the first communication terminal apparatus,
wherein the second communication terminal apparatus is configured to
transmit authentication information of the second communication terminal apparatus to the first communication terminal apparatus, the authentication information indicating whether authentication has been performed through an authentication station, and
wherein the first communication terminal apparatus is configured to:
receive authentication information of the another communication terminal apparatus from the another communication terminal apparatus, the authentication information indicating whether authentication has been performed through an authentication station,
determine reliability of a route from the communication terminal apparatus to the another communication terminal apparatus based on the received authentication information of the another communication terminal apparatus and the authentication information of the communication terminal apparatus,
transmit first data and second data having a lower importance than the first data to the another communication terminal apparatus, when the reliability is equal to or higher than a threshold, and
transmit the second data to the another communication terminal apparatus without transmitting the first data to the another communication terminal apparatus, when the reliability is lower than the threshold.
